(19) United States
(12) Patent Application Publication
(10) Pub. No.: US 2026/0085598 A1
(43) Pub. Date: Mar. 26, 2026

(54) REAL-TIME ANALYSIS AND PREDICTION USING INTEGRATED DATA (RAPID) FOR FRACTURE DRIVEN INTERACTION (FDI) DIAGNOSTICS

(71) Applicant: ConocoPhillips Company, Houston, TX (US)

(72) Inventors: Zhengxue Li, Houston, TX (US); Herbert Swan, Houston, TX (US); Brian K. Macy, Houston, TX (US); Brandon Williams, Houston, TX (US); Jonathan R. Snyder, Houston, TX (US)

(21) Appl. No.: 19/339,763

(22) Filed: Sep. 25, 2025

Related U.S. Application Data
(60) Provisional application No. 63/698,638, filed on Sep. 25, 2024.

(51) Int. Cl. E21B 43/26; E21B 47/12; G06F 18/27

(52) U.S. Cl. CPC E21B 43/26; E21B 47/12; G06F 18/27

(57) ABSTRACT

Implementations described and claimed herein provide systems and methods for detection, tracing, and prediction of frac hits (or other type of fracture driven interactions) via automated approaches using a variety of multi-disciplinary data. In some implementations, frac hits may be automatically detected in real-time using production data including pressure and production water, gas, and oil rates, as well as other in-well and well-head measurements via both deterministic and AI-based methods. The detected frac hit information may then be combined with completion data to identify likely subsurface location candidates for frac hit origins. Those location candidates can then be compared with subsurface fault distribution to identify the communication pathways for fluid and/or pressure. The above steps form a complete “Monitoring-Tracing-Prediction-Alerting” loop for frac hit diagnostics which can be used to support the completion and production of wells in real-time or in historical context.

### CROSS-REFERENCE TO RELATED APPLICATIONS

This application claims the benefit of priority to U.S. Provisional Patent Ser. No. 63/698,638 filed on Sep. 25, 2024, the entirety of which is incorporated by reference herein.

### FIELD

Aspects of the present disclosure relate generally to systems and methods for monitoring and analyzing fracture driven interactions (FDIs) and, more particularly, to an automated diagnostic system and method to monitor and analyze FDIs in real-time, including fracture hit detection and real-time alerting of the same, fracture hit origin identification and correlation, and fracture hit prediction.

### BACKGROUND

Hydraulic fracturing may be used to improve the recovery of hydrocarbons from the infill wells. During such operations, fracture-driven interferences (FDIs) may occur negatively impact the effectiveness of the fracturing process. In general, FDIs or “frac hits” occur when infill wells communicate with existing wells during completion. Typically, frac hits or other FDI events are analyzed after the completion of the hydraulic fracturing operation, with the goal of better informing the design of future hydraulic fracturing operations and the placement of additional wells. However, the detection of FDI events in near real time may provide significant advantages to currently operated wells. Detecting FDI events in real-time has some drawbacks, however, including that the data that tends to indicate the occurrence of a frac hit is both voluminous and distributed and difficult to consolidate for analysis in near real time. There is, therefore, a need for an improved system and method for detecting or predicting frac hits or other pressure anomalies in near real time. It is with these observations in mind, among others, that various aspects of the present disclosure were conceived and developed.

### SUMMARY

Implementations described and claimed herein address the foregoing problems by providing systems and methods for fracture driven interactions diagnostics. The systems and methods may include the operations of receiving, from a computing device, production data associated with a well being drilled and detecting, by a fracture hit detection model, a fracture hit event at the well, the fracture hit model receiving the production data as an input and outputting an indication of the fracture hit event. The operations may also include combining the production data and completion data of the well to determine a plurality of potential origins of the detected fracture hit event, determining an origin of the detected fracture hit event by overlaying subsurface data with the plurality of potential origins of the detected fracture hit event, and augmenting, based on the determined origin of the detected fracture hit event, a production component of the well.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 shows an example network environment that may implement various systems and methods discussed herein.

FIG. 2A is a block diagram illustrating a system for real-time fracture driven interactions diagnostics.

FIG. 2B is a diagram illustrating features of the system for real-time fracture driven interactions diagnostics.

FIG. 3 shows an example block diagram of a fracture driven interactions platform.

FIG. 4 illustrates example operations for a real-time fracture driven interactions diagnostics system to predict and respond to determined fracture hits.

FIG. 5 is an example plot of production data from one or more sites utilized to detect a fracture hit by a real-time fracture driven interactions diagnostics platform.

FIG. 6 is an example dataflow of a real-time fracture driven interactions diagnostics platform to detect a fracture hit event.

FIG. 7 illustrates an autoregressive moving average system to analyze past and to project future values of offset well pressures.

FIG. 8 illustrates a simple synthetic containing four artificial frac hits and illustrates how the claimed method of frac hit detection operates.

FIG. 9 illustrates how a combined FDI model and other numerical methods complement each other on a real-data example.

FIG. 10 illustrates a map of a general pattern of fractures that can be mapped by the method disclosed herein.

FIG. 11 illustrates the pressure in two wells near an ongoing stimulation job.

FIG. 12 illustrates an automated procedure to determine associating groups of FDIs with the same fracture.

FIG. 13 illustrates a map of the fractures that may have been deemed to have emanated from a well as a result of its stimulation.

FIG. 14 shows an example computing system that may implement various systems and methods discussed herein.

### DETAILED DESCRIPTION

Aspects of the present disclosure involve systems and methods for detection, tracing, and prediction of frac hits (or other type of fracture driven interactions (FDIs)) via automated approaches using multi-disciplinary (Production, Completion and Subsurface) data. In some instances, frac hits (or FDIs) may be automatically detected in real-time using production data including (but not limited to) pressure, water rate, gas rate and oil rate as well as other in-well and well-head measurements via both deterministic and AI-based methods. The detected frac hit information may then be combined with completion data (the stage location and completion schedule) to track down subsurface location candidates for frac hit origins. Those location candidates are then jointly analyzed by overlying subsurface fault distribution to identify the most likely frac hit communication paths for fluid and/or pressure. The above steps form a complete “Monitoring-Tracing-Prediction-Alerting” loop for frac hit diagnostics which can be used to support completion and production of wells in real-time.

These and other advantages may become apparent from the discussion included herein.

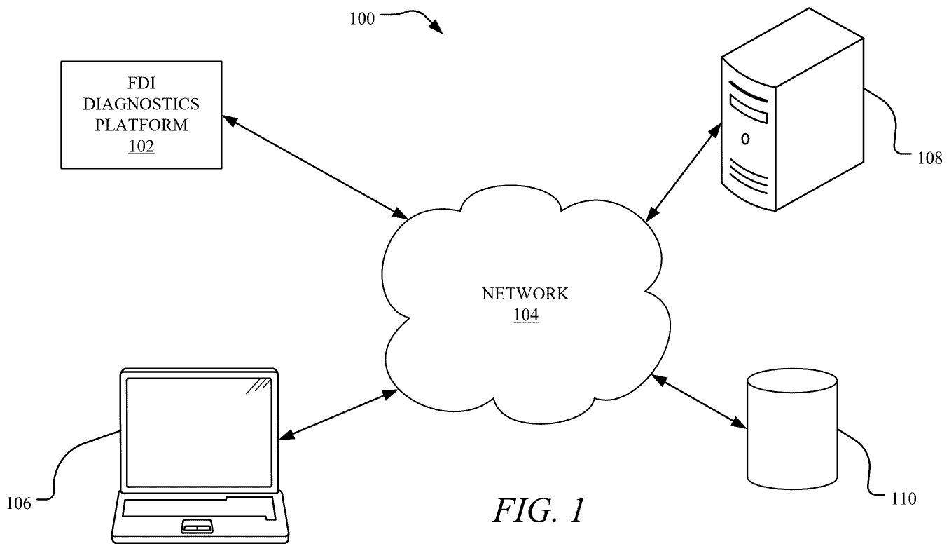

To begin a detailed discussion of an example reservoir depletion assessment system, reference is made to FIG. 1. In particular, FIG. 1 illustrates an example network environment 100 for implementing the various systems and methods, as described herein. As depicted, a network 104 is used by one or more computing or data storage devices for implementing the systems and methods for real-time fracture driven interactions (FDI) diagnostics. In one implementation, various components of the FDI diagnostics platform 102, one or more user devices 106, one or more databases 110, and/or other network components or computing devices described herein are communicatively connected to the network 104. Examples of the user devices 106 include a terminal, personal computer, a smart-phone, a tablet, a mobile computer, a workstation, and/or the like.

A server 108 may, in some instances, host the system. In one implementation, the server 108 also hosts a website or an application that users may visit to access the network environment 100, including the FDI diagnostics platform 102. The server 108 may be one single server, a plurality of servers with each such server being a physical server or a virtual machine, or a collection of both physical servers and virtual machines. In another implementation, a cloud hosts one or more components of the system. The FDI diagnostics platform 102, the user devices 106, the server 108, and other resources connected to the network 104 may access one or more additional servers for access to one or more websites, applications, web services interfaces, etc. that are used for reservoir modeling.

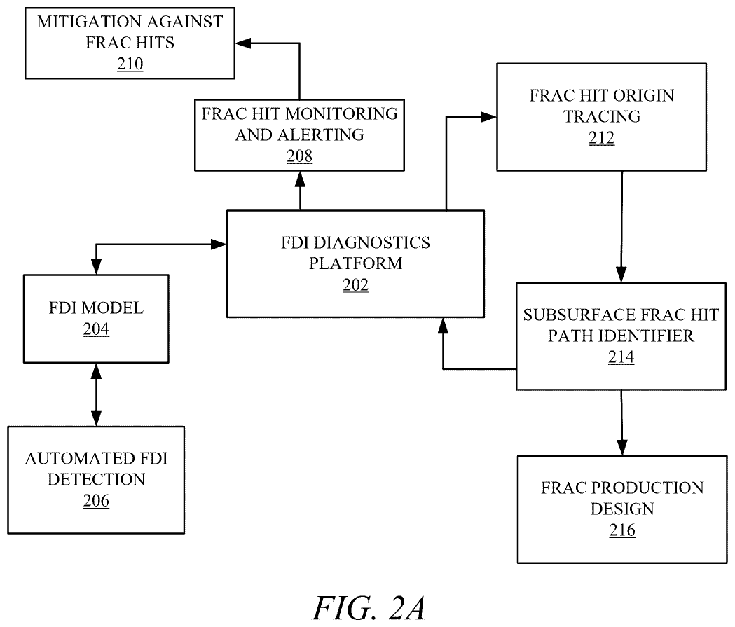

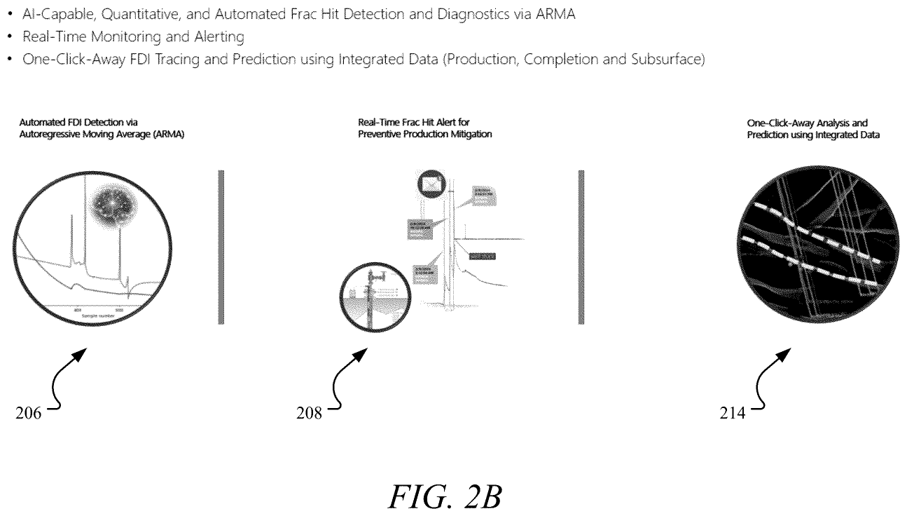

FIG. 2A is a block diagram illustrating a system 200 for real-time fracture driven interactions diagnostics and FIG. 2B is a diagram illustrating features of the system for real-time fracture driven interactions diagnostics. The system 200 of FIG. 2 may include more or fewer components than those illustrated. In the example shown, an FDI diagnostics platform 202 is provided for fracture driven diagnostics of a site or sites. As described in more detail below, the FDI diagnostics platform 202 may provide an automated diagnostic flow to monitor and analyze FDIs in real-time or near real-time. The platform 202 may include components and/or methods for frac hit detection and real-time alerting of detected frac hits, frac hit origin identification and correlation to subsurface features, and frac hit prediction and alerting. Such features may be executed automatically with little to no interaction from an operator of the FDI diagnostics platform 202.

As illustrated in FIGS. 2A and 2B, the FDI diagnostics system 200 may utilize an FDI model 204 to automatically detect an FDI event 206. The FDI model 204 may be a both or either a deterministic model or based on one or more machine-learning or artificial intelligence (AI) algorithms. In some particular examples, the FDI model 204 may include autoregressive moving average (ARMA) techniques, as described in greater detail below. Inputs to the FDI model 204 may include production data from a well, including but not limited to, pressure, water rate, gas rate, oil rate, or any other in-well or well-head measurements obtained from the well. Through analysis and processing the inputs, the FDI model 204 may generate a detection of an FDI event 206. As mentioned, the FDI model 204 may be a deterministic model that includes weights, parameters, threshold values, etc. associated with the inputs and determines if an FDI event 206 has occurred or is occurring in the well. Such parameters of the FDI model 204 may, in some instances, be altered based on historical performance data of the FDI model through one or more machine-learning or AI algorithms. For example, the FDI model 204 may provide a determination of an FDI event based on a collection of production data from a well. Subsequent to providing the determination, the FDI diagnostics platform 202 may determine that the FDI event did not occur and provide an indication of the accuracy of the detection to the FDI model 204 for retraining. One or more parameters of the FDI model 204 may then be adjusted or altered in response to the indication of the accuracy of the detection of the FDI event to improve the accuracy of the model 204. In this manner and over multiple iterations of prediction, feedback, and adjusting, the FDI model 204 may become more accurate over time. In general, any known or hereafter developed machine-learning or AI algorithm may be utilized to train the FDI model 204 based on inputs and determination outputs of the model.

As noted, the FDI model 204 may provide a determination of a detected FDI event 206 or frac hit to the FDI diagnostics platform 202. In response, the platform 202 may provide utilize a frac hit monitoring and alerting system 208 to generate one or more alerts indicating the detection of the frac hit. For example, the monitoring and alerting system 208 may generate any type of electronic communication or notice, such as a text message, a telephone call, an email, a pop-up communication on a display of a computing device, and the like. Such communications may be transmitted to a communication device or other computing device associated with an operator of the monitored well. For example, the alerting system 208 may generate an email and transmit the email to an inbox of an operator of the monitored well. The generated email may include information associated with the output of the FDI model 204 determining the FDI event 206, such as a link to access the FDI diagnostics platform 202 and view or otherwise obtain a report of the output of the FDI model 204. The link may be selected by a user through an input to the computing device to direct a browser or other application executed on the computing device to access the FDI diagnostics platform 202 and obtain the information. In general, the generated communication and/or alert may include any data, information, links, analysis, etc. associated with the detected frac hit and monitored well.

In some instances, the alert 206 generated and transmitted by the FDI diagnostics platform 202 may include instructions to one or more components of monitored well to activate or execute a mitigation action 210 on the well to address the detected frac hit. For example, the alert 206 may include instructions to adjust a drilling component of the monitored well to prevent mitigate the effects of the detected frac hit. In other instances, the generated alert 206 may include instructions or access to one or more components of the monitored well to an operator or administrator of the well. The instructions and/or access may direct the receiver to alter the operating condition of the well equipment to mitigate the negative effects of the detected frac hit. In general, the alert 206 generated by the FDI diagnostics platform 202 may alter or cause the alteration of the operation of any aspect of the monitored well in response to the frac hit detected by the model 204 and received at the FDI diagnostics platform 202. Further, as described in more detail below, the alert 206 may include additional information, such as correlation of the detected FDI event 206 to one or more subsurface location candidates for the frac hit origin.

In addition to the detection and alerting of FDI events, the FDI diagnostics system 200 may execute automated frac hit or FDI event tracing 212. In one implementation, the detected FDI event information from the FDI model 204 may be combined with completion data (the stage location and completion schedule for the well) to identify subsurface fault distribution and potential subsurface location candidates for an origin or origins for the FDI event. The method of combining the detected FDI event information and the completion data to identify subsurface fault distribution and potential subsurface location candidates is described in greater detail below. Further, the system 200 may jointly or subsequently overlay subsurface fault distribution data with the identified subsurface location candidates to identify the most likely frac hit communication for fluid and/or pressure at a subsurface frac hit path identifier component 214. The information generated by the frac hit path identifier 214 may be fed back, in some instances, to the FDI diagnostics platform 202 for inclusion in the alert 206 generated by the platform. In particular, the FDI system 200 of FIG. 2 generates a Monitoring-Tracing-Prediction-Alerting loop for FDI events for any number of monitored wells.

In one implementation, the system 200 may accumulate the information generated by the frac hit path identifier 214 for use in generating or altering frac production design 216 for one or more wells. For example, processing of the frac hit path identifier 214 information based on the real-time monitoring of the wells may indicate that one or more wells from a plurality of wells is contributing to frac hits or other FDI events at the site of the wells. In response, one or more plans or designs 216 for the site may be adjusted to account for the determined frac hit path identifications, typically to avoid future frac hits from those identified paths. In this manner, the site development design may be optimized based on the FDI event data and determination executed by the FDI diagnostics system 200.

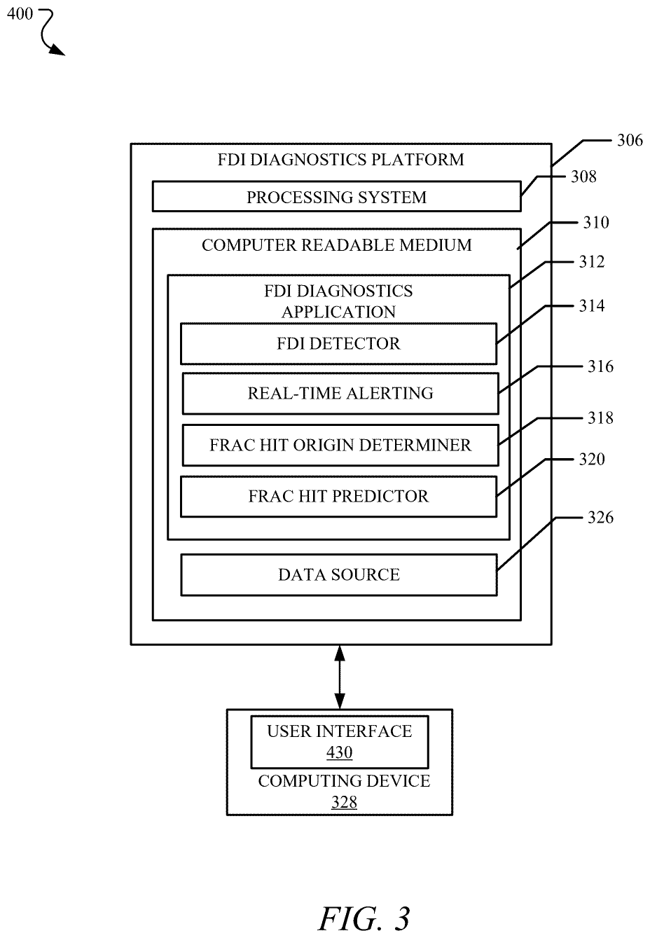

FIG. 3 shows an example block diagram of a FDI diagnostics system 300 for detecting, tracing, and/or predicting FDI events (such as frac hits) via an automated system using multi-disciplinary data, such as production data, completion data, and/or subsurface data or one or more wells being monitored. In general, the system 300 may include a FDI diagnostics platform 306. In one implementation, the FDI diagnostics platform 306 may be a part of the FDI diagnostics platform 202 or several components of the FDI diagnostics system 200 of FIG. 2. As shown in FIG. 3, the FDI diagnostics platform 306 may be in communication with a computing device 328 providing a user interface 330. As explained in more detail below, the FDI diagnostics platform 306 may be accessible to various users to detect, trace, and/or predict FDI events. In some instances, access to the FDI diagnostics platform 306 may occur through the user interface 330 executed on the computing device 328.

The FDI diagnostics platform 306 may include an FDI diagnostics application 312 executed to perform one or more of the operations described herein. The FDI diagnostics application 312 may be stored in a computer readable media 310 (e.g., memory) and executed on a processing system 308 of the depletion assessment platform 306 or other type of computing system, such as that described below. For example, the FDI diagnostics application 312 may include instructions that may be executed in an operating system environment, such as a Microsoft Windows™ operating system, a Linux operating system, or a UNIX operating system environment. By way of example and not limitation, non-transitory computer readable medium 310 comprises computer storage media, such as non-transient storage memory, volatile media, nonvolatile media, removable media, and/or non-removable media implemented in a method or technology for storage of information, such as computer readable instructions, data structures, program modules, or other data.

The FDI diagnostics application 312 may also utilize a data source 326 of the computer readable media 310 for storage of data and information associated with the FDI diagnostics platform 306. For example, the FDI diagnostics application 312 may store aspects of the FDI model 204 (such as the model itself and/or adjustable parameters of the model), historical outputs data of the FDI model, data associated with subsurface location candidates, and the like. As described in more detail below, such data may be stored and accessed via the user interface 330 for one or more users of the FDI diagnostics platform 306.

The FDI diagnostics application 312 may include several components for automatic detecting, tracing, and/or predicting FDI events in real-time. For example, the FDI diagnostics application 312 may include a frac hit detector 314 component. The FDI detector 314 may include some or all of the FDI model 204 discussed above to determine the occurrence or potential occurrence of an FDI event. For example, the FDI detector 314 of the application 312 may receive input production data from a well and output a determination or likelihood of a frac hit of the monitored well or wells. The FDI detector 314 may include some or all of a deterministic model or machine-learning/AI model, as described above. In addition, the FDI diagnostics application 312 may include a real-time alerting 316 module to generate an alert to an operating system of one or more monitored wells in response to the output from the FDI detector 314. As described above, the alert may comprise any type of electronic communication, such as a text, an email, an instruction to control one or more systems of the monitored well, and the like.

Further, the real-time alerting module 316 may include, in the generated alert, information received from the frac hit origin determiner 318 and/or the frac hit predictor 320. In general, the frac hit origin determiner 318 may combine the detected FDI event information from the FDI detector 314 with completion data (the stage location and completion schedule) for one or more wells to identify subsurface fault distribution and potential subsurface location candidates for an origin or origins for the FDI event. The frac hit predictor 320 may utilize the frac hit origin determination to understand which wells may be contributing to frac hits or other FDI events at the site of the wells. The operations of both the frac hit origin determiner 318 and the frac hit predictor 320 are discussed in more detail below.

It should be appreciated that the components described herein are provided only as examples, and that the FDI diagnostics application 312 may have different components, additional components, or fewer components than those described herein. For example, one or more components as described in FIG. 3 may be combined into a single component. As another example, certain components described herein may be encoded on, and executed on other computing systems. Further, more or fewer of the components discussed above with relation to the depletion assessment platform 306 may be included with the tool, including additional components or modules included to perform the operations discussed herein.

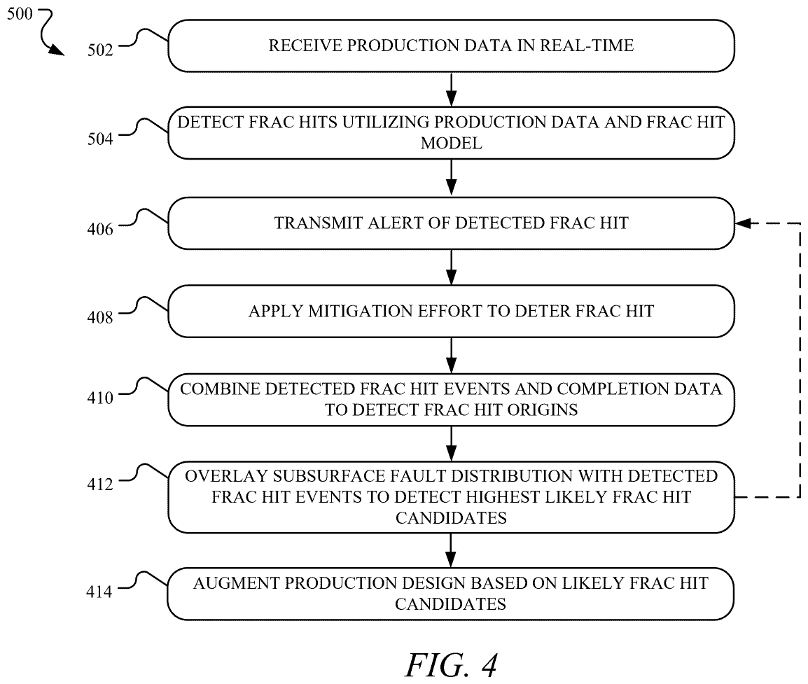

FIG. 4 illustrates example operations for a real-time fracture driven interactions diagnostics system to predict and respond to determined fracture hits. The operations may be performed by a computing device configured to execute instructions, such as the FDI diagnostics platform 102 of FIG. 1. Such operations may be executed through control of one or more hardware components, one or more software programs, or a combination of both hardware and software components of the computing device. In another example, the FDI application 312 executed by the FDI diagnostics platform 306 may perform one or more of the operations.

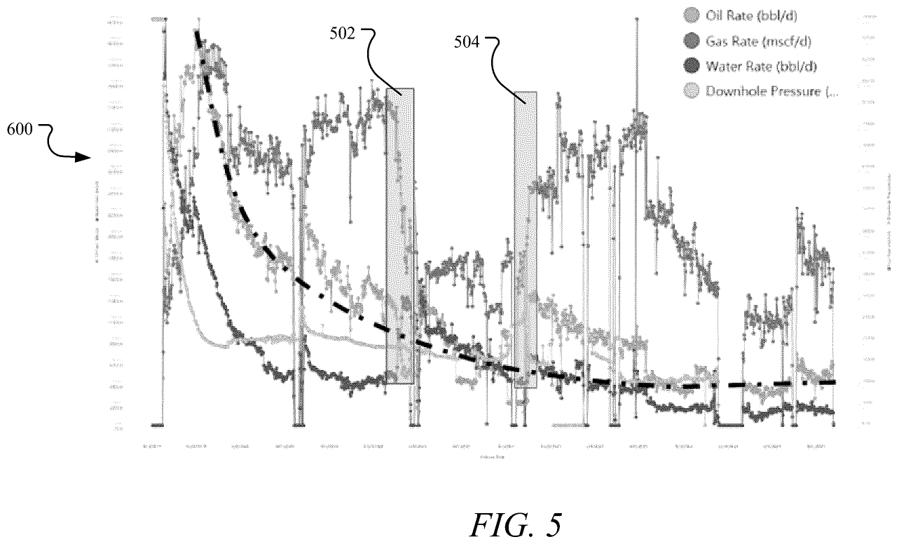

Beginning at operation 402, the FDI diagnostics application 312 may receive production data of a monitored well. In some instances, the received production data may be received in real-time or near real-time and may include, but is not limited to, water rate, gas rate, oil rate, or any other in-well or well-head measurements obtained from the well. One example of production data that may be received in illustrated in the graph of FIG. 5. In particular, the graph illustrates a received oil rate, gas rate, water rate, and downhole pressure of a monitored well, graphed over a period of time. Additional or fewer production data may also be received and graphed or cataloged accordingly.

At operation 404, the application 312 may utilize the frac hit model 204 to input the received production data and output some indication of a detection of a frac hit. In some instances, the output may include a value indicating a likelihood a frac hit event has occurred. In other instances, the output may include an indication that a frac hit event has been detected. Also, as described above, the frac hit model 204 may be a deterministic model, a machine-learning/AI model, or a combination of both types of models. One example of the analysis performed by the frac hit model is illustrated in FIG. 5. In particular, the frac hit model 204 may analyze the received production data, such as that illustrated in FIG. 5, over any period of time to determine the combination of types of production data, production trends, data values, etc. that indicate a frac hit event at a monitored well. For example, the model 204 analyze periods of lower gas rates 502 and/or periods of higher gas rates 504. In general, the frac hit model 204 may analyze any number of production data or any period of time to determine a frac hit event. In some instances, the machine-learning or AI model 304 may be trained with historical data to determine which production data best indicates a frac hit and/or a period of time over which such data is analyzed to optimize the frac hit detection.

At operation 406, the FDI diagnostics application 312 may transmit an alert of the detected frac hit to one or more computing devices associated with an affected well. As explained above, the computing device may be associated with an operator or operating system of the monitored well. The alert may be any electronic communication or instruction to alert a receiving system to the detected frac hit and/or to alter the operation of the well based on the detected frac hit event. Thus, in operation 408, one or more mitigation efforts may be applied to the monitored well to deter the effects of the detected frac hit. For example, the transmitted alert may include an instruction for a component of the monitored well to adjust the pressure within the well to offset the detected frac hit event. In general, any aspect of the operation of the well may be altered in response to the generated and transmitted alert.

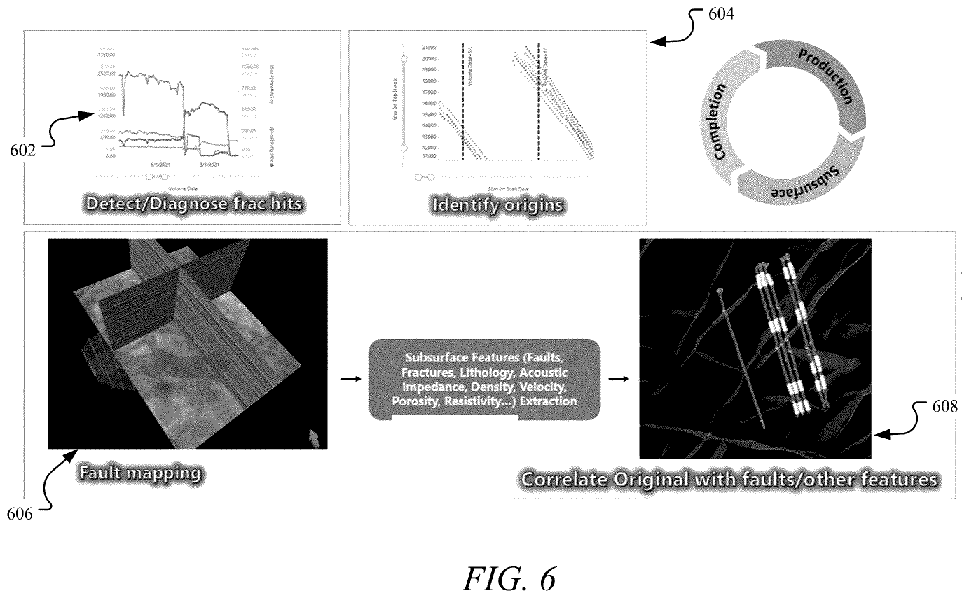

In addition to alerting an operation entity of the detected frac hit, the FDI diagnostics application 312 may also attempt to identify an origin of the frac hit event. In operation 410, the FDI diagnostics application 312 may combine the detected frac hit with completion data of the monitored well or wells to detect the origins of the frac hit. In particular, FIG. 6 illustrates a dataflow of the FDI diagnostics platform 102 for fracture driven diagnostics of a site or sites. As discussed above, the FDI diagnostics platform 102 may receive production data 602 and utilize such data, with a frac hit model 204, to detect a frac hit event. Further, the production data 602 may be combined with well completion data 604 of the monitored site or sites to identify the potential origins of the frac hit event. In addition, the combined production data 602 and completion data 604 may be integrated with subsurface distribution data 606 to determine the most likely candidate for the origin of the frac hit event in operation 412. In one implementation, the combined production data 602 and completion data 604 may be overlayed with subsurface imaging data 606 to generate an integrated image 608 or data that indicates the highest likely candidate for the origin of the detected frac hit event. Thus, the FDI diagnostics platform 102 may not only detect frac hit events, but may also determine an origin of the event based on subsurface data.

In some instances, the highest likely candidates for the frac hit may be transmitted to one or more computing devices, as indicated in the dotted line of FIG. 4. The candidate information may be transmitted in addition to or with the frac hit alert discussed above. Further, at operation 414, some aspect of a production design for one or more sites may be augmented based on the likely frac hit candidates. For example, a production plan for a well may be adjusted to account for a detected frac hit candidate to mitigate the effects of the frac hit origin.

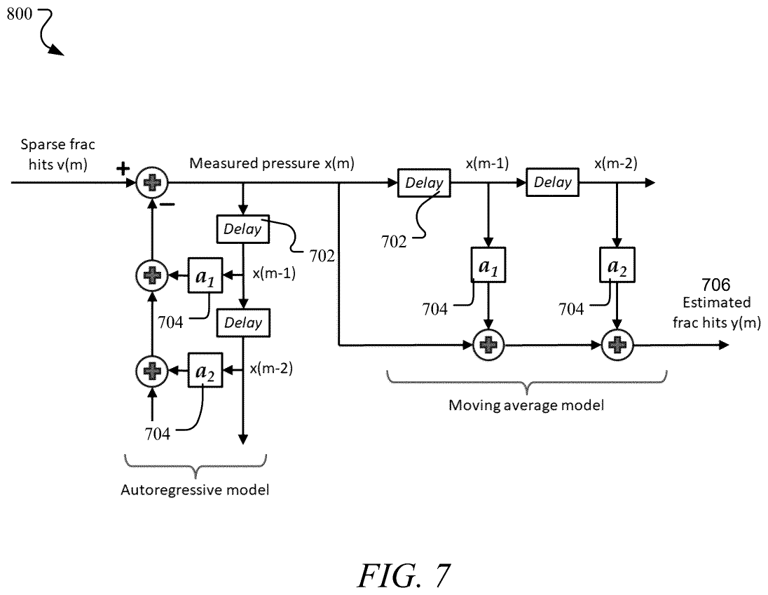

FIG. 7 illustrates one example of a frac hit detection method that may be utilized by one or more of the systems or components described herein. In some instances, the proposed frac hit detection method may be referred to as an autoregressive moving average (ARMA) method or system that utilizes past and projected future values of offset well pressures to predict a frac hit. A well's current condition information and/or data may include a production state (whether it is producing or shut in), a flow rate, a pump rotation frequency, and gas lift parameters. In general, if a fracture from a nearby treatment well interacts with any part of the monitored well, the pressure of the well will suddenly change, as fluids enter a new flow regime. Such an interaction is referred to herein as a fracture-driven interaction (FDI), or more simply a frac hit. The ARMA method may model the frac hit effect on the well as a linear process as the pressures approximately satisfy a linear differential equation and because the monitored response due to multiple frac hits will match the sum of the individual frac hit responses.

Linear systems, such as the interaction between treatment and monitor wells, can be modeled by the autoregressive moving-average (ARMA) system, such as what is shown in FIG. 7. In some embodiment, the “Delay” boxes 702 of the dataflow 700 may be memory cells whose outputs recall the value of their inputs from the prior sample period, assuming a fixed-rate of data sampling. The variable m of the dataflow 700 represents the sample number. A linear combination of the memory cell outputs is formed, using tap weights a1, . . . , aN 704, where Nis the number of weights, which comes from a user parameter order. The function v(m) represents a sequence of FDIs (or frac hits) coming from the treatment well. Since it is assumed that these interactions will occur relatively infrequently compared to the sampling interval, long spans of zero v(m) are to be expected.

There are two main applications of this ARMA system: analysis and projection. For the analysis application, the autoregressive portion of the ARMA system may not be implemented in software. Instead, the autoregressive portion may serve as a model of processes that take place in the subsurface. The inputs to v(m) and tap weights a1, . . . , aN are typically unknown. Rather, only the outputs are known, which may be the pressure measurements x(m) taken from the monitor well. These measurements are fed into a moving average portion of the model and the weights may be adjusted so as to minimize the rms value of its output y(m) between frac hits.

For the projection application, the modelling of the subsurface processes may be forwarded to estimate what the measured pressure at the monitor well would have been had a frac hit not occurred. This is generally done by implementing the autoregressive using the tap weights obtained during an analysis phase and the initial conditions obtained from prior measurements.

As illustrated in FIG. 7, the tap weights 704 of the autoregressive portion of the ARMA system 700 may be the same as those of the moving average portion. However, the two sets of weights may not match each other. However, if they do match, then the moving average (MA) of the dataflow 700 will be the inverse of the autoregressive (AR) model. To illustrate, the model can be expressed as response x(m) in terms of the actual frac hits v(m):

$$x ( m ) = v ( m ) - {\sum }_{k = 1}^{N} {a}_{k} x ( m - k ) . \qquad ( 1 )$$

The estimated frac hits may also be expressed in terms of the modeled response x(m):

$$y ( m ) = x ( m ) + {\sum }_{k = 1}^{N} {a}_{k} x ( m - k ) . \qquad ( 2 )$$

Starting at m=0 and beyond, and for constant tap weights aₖ, the value of x(m) depends only on the input sequence v(k) and the initial conditions {x(−N), x(1−N), . . . , x(−1)} of the autoregressive memory cells. Furthermore, the value of y(m) depends only on x(m) and the initial conditions of the moving average memory cells. For simplicity, let us initialize the autoregressive memory cells with the same values as the moving average cells. Then, if we substitute first equation into the second equation, we see that MA is indeed the inverse of the AR system.

$$y ( m ) = v ( m ) - {\sum }_{k = 1}^{N} {a}_{k} x ( m - k ) + {\sum }_{k = 1}^{N} {a}_{k} x ( m - k ) = v ( m ) . \qquad ( 3 )$$

Assuming a quiet period before the start of the next frac hit, then both v(m) and y(m) will be zero. Conversely, if at some point for m>0, y(m) does not equal 0, a frac hit has occurred at to near this point.

The tap weights 704 may be deduced to ensure that y(m) will be zero prior to a frac hit. This may correspond to the analysis application of the ARMA system 700, where the measured monitor well pressures is fed into the moving average, as shown in FIG. 7. In particular, if the second equation is written as a system of equations, the following for 0≤m<M is obtained:

$$y ( 0 ) = x ( 0 ) + {a}_{1} x ( - 1 ) + {a}_{2} x ( - 2 ) + … + {a}_{N} x ( - N ) \\ y ( 1 ) = x ( a ) + {a}_{1} x ( 0 ) + {a}_{2} x ( - 1 ) + … + {a}_{N} x ( 1 - N ) \\ ⋮ \\ y ( M - 1 ) = x ( M - 1 ) + {a}_{1} x ( M - 2 ) + {a}_{2} x ( M - 3 ) + … + {a}_{N} x ( M - N - 1 ) \qquad ( 4 )$$

The initial number of points M may be derived from a user parameter. In matrix form, the system of equations may be written in matrix form as:

$$\vec{y} ( M ) = [ \text{} \begin{matrix}y ( 0 ) \\ y ( 1 ) \\ ⋮ \\ y ( M - 1 )\end{matrix} ] = [ \text{} \begin{matrix}x ( 0 ) \\ x ( 1 ) \\ ⋮ \\ x ( M - 1 )\end{matrix} ] + [ \text{} \begin{matrix}x ( - 1 ) & x ( - 2 ) & … & x ( - N ) \\ x ( 0 ) & x ( - 1 ) & … & x ( 1 - N ) \\ & & ⋮ & \\ x ( M - 2 ) & x ( M - 3 ) & … & x ( M - N - 1 )\end{matrix} ] [ \begin{matrix}{a}_{1} \\ {a}_{2} \\ ⋮ \\ {a}_{N}\end{matrix} ] , \qquad ( 5 )$$

or in the shortened symbolic form:

$$\vec{y} ( M ) = \vec{x} ( M ) + {L}_{M} \vec{a} , \qquad ( 6 )$$

where \vec{y}(M) is the length M vector of estimated frac hits through sample M−1, \vec{x}(M) is the length M vector of the monitored pressures, L_{M} is the M λ N model matrix of the moving average, and a is the length N vector of the model tap weights 704. The summed-square value of \vec{y}(M), which is denoted by the scalar E, may be found by taking the inner product of \vec{y}(M) with itself:

$$E = {\vec{y} ( M )}^{T} \vec{y} ( M ) = [ {\vec{x} ( M )}^{T} + {\vec{a}}^{T} {L}_{M}^{T} ] [ \vec{x} ( M ) + {L}_{M} \vec{a} ] , \qquad ( 7 )$$

where the superscript T denotes “transpose.” The optimal weight vector â is the one which minimizes E. To find it, the derivative of E with respect to each of the tap weights may be set to zero:

$$\frac{d E}{d \vec{a}} = 2 {L}_{M}^{T} \vec{x} ( M ) + 2 {L}_{M}^{T} {L}_{M} \hat{a} = 0. \qquad ( 8 )$$

This means that the optimal weight vector is given by:

$$\hat{a} = - {( {L}_{M}^{T} {L}_{M} )}^{- 1} {L}_{M}^{T} \vec{x} ( M ) = - {R}_{M}^{- 1} {X}_{M} , \qquad ( 9 )$$

where

$${R}_{M} = {L}_{M}^{T} {L}_{M}$$

is the N×N autocorrelation matrix of first M pressure measurements and

$${X}_{M} = {L}_{M}^{T} \vec{x} ( M )$$

is the N×1 cross-correlation matrix between the current and previous steps of the first M measurements.

The equations above provide one method to obtain the optimal set of tap weights 704 to minimize the sum of the first M squared values of \vec{y}. However, since the pressure transients in the monitored well are nonstationary, the ARMA weight values may be adapted to match the changing characteristics. As new data points are received, a method to efficiently but gradually update the statistics may be implemented. In addition, stale data points in the statistics may not be included as those points are no longer relevant. Thus, the ARMA method may add and remove points efficiently in real-time, without having to recompute the auto and cross correlation matrices each time.

In one implementation, assume one additional data point, x(M), is to be added. Equation (5) above may then be written as:

$$\vec{y} ( M + 1 ) = [ \begin{matrix}\vec{y} ( M ) \\ y ( M )\end{matrix} ] = {\underbrace{[ \begin{matrix}\vec{x} ( M ) \\ x ( M )\end{matrix} ]}}_{{\vec{x}}_{M + 1}} + {\underbrace{[ \begin{matrix}{L}_{M} \\ {\vec{ζ}}_{M}^{T}\end{matrix} ]}}_{{L}_{M - 1}} \vec{a} , \qquad ( 10 )$$

where

$${\vec{ζ}}_{M}^{T}$$

is a vector of the last N measurements made prior to sample M:

$${\vec{ζ}}_{M}^{T} = [ x ( M - 1 ) x ( M - 2 ) … x ( M - N ) ] . \qquad ( 11 )$$

The updated autocorrelation matrix may now be obtained recursively from its prior value:

$${R}_{M + 1} = {\underbrace{[ \begin{matrix}{L}_{M}^{T} & {\vec{ζ}}_{M}\end{matrix} ]}}_{{L}_{M + 1}^{T}} {\underbrace{[ \begin{matrix}{L}_{M} \\ {\vec{ζ}}_{M}^{T}\end{matrix} ]}}_{{L}_{M + 1}} = {L}_{M}^{T} {L}_{M} + {\vec{ζ}}_{M} {\vec{ζ}}_{M}^{T} = {R}_{M} + {\vec{ζ}}_{M} {\vec{ζ}}_{M}^{T} . \qquad ( 12 )$$

Note that

$${\vec{ζ}}_{M} {\vec{ζ}}_{M}^{T}$$

is an N×N matrix of rank 1, known as the outer product of ζ_{M}. The updated cross-correlation matrix may also be computed recursively:

$${X}_{M + 1} = {\underbrace{[ \begin{matrix}{L}_{M}^{T} & {\vec{ζ}}_{M}\end{matrix} ]}}_{{L}_{M + 1}^{T}} {\underbrace{[ \begin{matrix}{\vec{x}}_{M} \\ x ( M )\end{matrix} ]}}_{{\vec{x}}_{M + 1}} = {L}_{M}^{T} \vec{x} ( M ) + {\vec{ζ}}_{M} x ( M ) = {X}_{M} + {\vec{ζ}}_{M} x ( M ) \qquad ( 13 )$$

In addition to incorporating new measurements into the model, old or obsolete measurements may also be removed. At the beginning of the recorded data stream, or after a frac hit is detected, the ARMA method may compute the tap weights 704 based on the next M samples, where M is a user-defined parameter. After that, if the number of samples processed since the last hit or the beginning of the data exceeds W samples (where W is another user-defined parameter), the updated auto and cross-correlation matrices may be computed from:

$${R}_{M + 1} = {R}_{M} + {\vec{ζ}}_{M} {\vec{ζ}}_{M}^{T} - {\vec{ζ}}_{M - W} {\vec{ζ}}_{M - W}^{T} \qquad ( 14 )$$

$${X}_{M + 1} = {X}_{M} + {\vec{ζ}}_{M} x ( M ) - {\vec{ζ}}_{M - W} x ( M - W ) . \qquad ( 15 )$$

The updated tap weights 704 may now be computed through Equation (9) using the updated auto and cross-correlation matrices from Equations 12-25.

The taps weights 704 for both portion of the ARMA method involve finding the inverse of the autocorrelation matrix R. Two methods may be utilized to ensure that either a singular, or highly ill-conditioned autocorrelation will not lead to wild results. The two methods may be referred to as the singular value decomposition (SVD) and constraining the magnitude of the weight vector. One or both methods may be used simultaneously.

In the singular value decomposition method, the inversion stabilization involves expanding the R matrix in the following form:

$$R = U Δ V . \qquad ( 16 )$$

All of the matrices in this expansion are N×N square matrices. U and V are orthonormal matrices such that UU^{T}=VV^{T}=I. The columns of U span the column space of R, and the rows of V span the row space of R. Δ is a diagonal matrix, whose values are the eigenvalues of R:

$$Λ = [ \begin{matrix}{λ}_{1} & & & \\ & {λ}_{2} & & \\ & & ⋱ & \\ & & & {λ}_{N}\end{matrix} ] . \qquad ( 17 )$$

Since R is an autocorrelation matrix, all of its eigenvalues will be nonnegative, but one or more of them could be zero or be very small. These eigenvalues may be ordered.

If R is invertible (nonsingular), then:

$${R}^{- 1} = {V}^{- 1} {Δ}^{- 1} {U}^{- 1} = {V}^{T} {Δ}^{- 1} {U}^{T} , \qquad ( 18 )$$

where:

$${Λ}^{- 1} = [ \begin{matrix}{λ}_{1}^{- 1} & & & \\ & {λ}_{2}^{- 1} & & \\ & & ⋱ & \\ & & & {λ}_{N}^{- 1}\end{matrix} ] . \qquad ( 19 )$$

At this point, if any eigenvalue is smaller than a certain percentage of the largest eigenvalue, then its corresponding value in Equation (19) is also set to zero and used in Equations (18) and (9) to compute the ARMA tap weights 704.

The other method of stabilizing the inversion is to redefine the error term of Equation (7) to include a term for the magnitude of the tap weights 704:

$$E = {\vec{y} ( M )}^{T} \vec{y} ( M ) + α {\vec{a}}^{T} \vec{a} , \qquad ( 20 )$$

where α comes from a parameter. Equation (9) may therefore be modified to become:

$$\hat{a} = - {( {R}_{M} + ∝ I )}^{- 1} {X}_{M} . \qquad ( 21 )$$

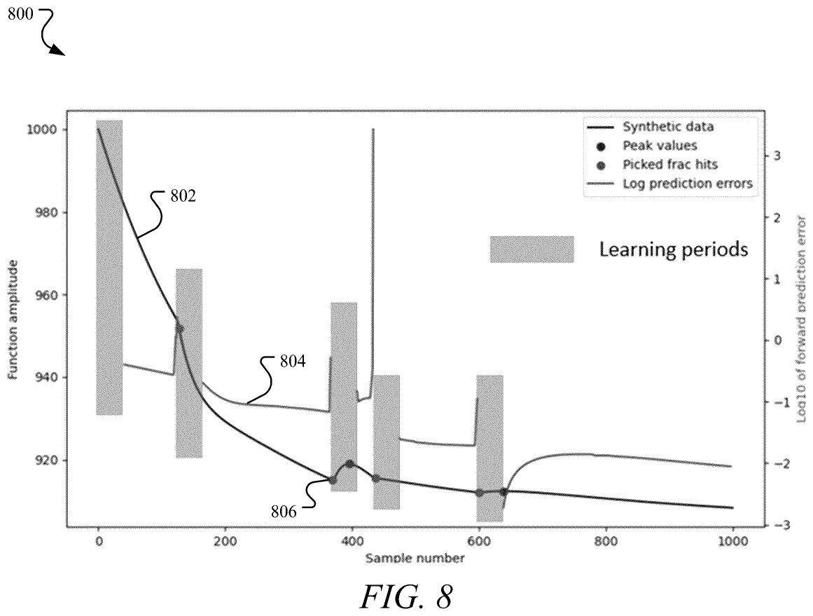

FIG. 8 illustrates a simple synthetic containing four artificial frac hits and illustrates how the claimed method of frac hit detection operates. In particular, line 802 illustrates one example of determined offset pressure data. The model disclosed herein, in general, utilizes a training period to learn the statistical properties of the time series being modeled. In this example, this training period is 40 samples. During this period, no FDIs are reliably detected. However, once the training period has passed, prediction of future values of pressure based on the past can be made. The prediction error is the prediction of the model minus the actual value. For example, the logarithm of the absolute prediction error is shown as line 804 of the graph of FIG. 8.

When a fracture hits 806 the monitor well, a baseline statistical behavior changes suddenly, and a new learning period may be set aside for the model to learn this new behavior. After this second learning period, predictions can once again be made. Whenever a spike in the prediction error occurs, a new frac hit may be detected. The sensitivity of the method can thus be changed by adjusting the threshold of log amplitude that will trigger the detection. A total of four such detections were illustrated in this example.

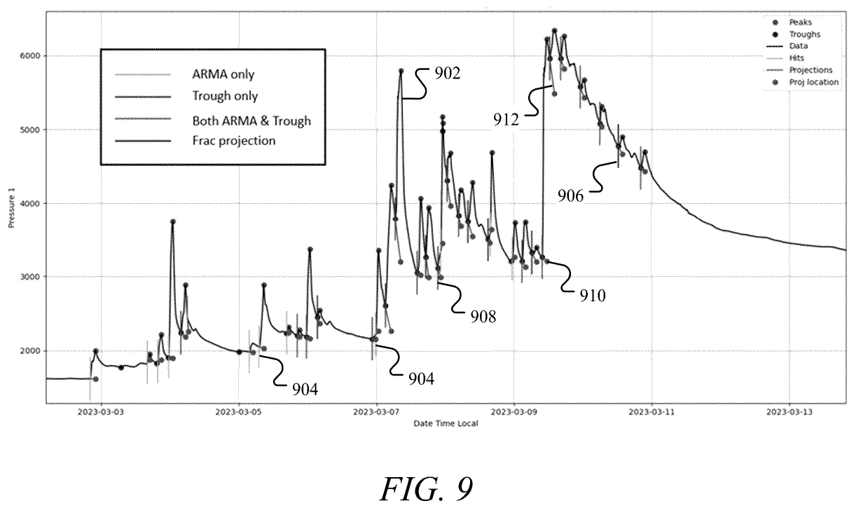

FIG. 9 illustrates how a combined FDI model and other numerical methods complement each other on a real-data example. As illustrated in FIG. 9, line 902 is the pressure recorded at the offset well. In general, the vertical line segments are located at the beginnings of each of the detected FDIs. Yellow lines 904 were detected only by the FDI model. In this example, green lines 906 were detected by the trough-detecting method of the other numerical methods. Green lines 908 were detected by both methods. In general, neither method was able to detect all the FDIs, with red lines 912 illustrating future values of the pressure as predicted by the FDI model. The red dots 910 are placed at the FDI ending times, i.e., the times at which the FDI magnitudes are measured.

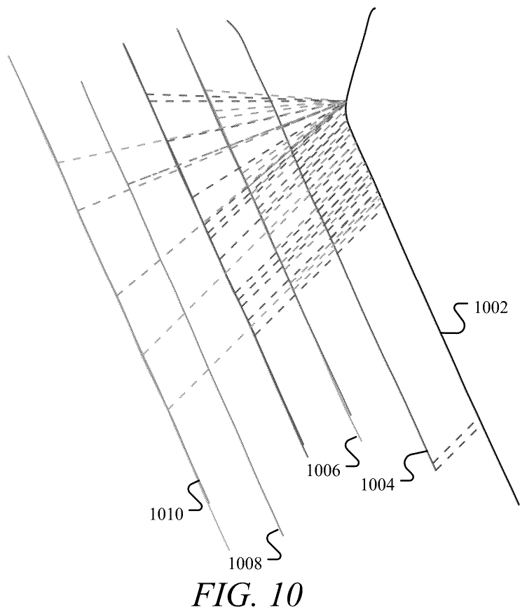

The utility of this method may be improved by assigning the origin of the frac hits that were detected to the stage of which well is being stimulated. FIG. 10 illustrates a map of a general pattern of fractures that can be mapped by the method disclosed herein. The right-most well 1002 on this map is an illustration of an observation well, whose pressure is recorded and analyzed. The other wells 1004-1010 are illustrations of those being stimulated as the time pressure data from the observation well is being recorded.

A procedure for obtaining a fracture map, such as the one shown in FIG. 10, may be as follows: 1) Find observation wells close enough to be affected by nearby stimulation wells; 2) Calculate the distance and azimuth from every stage of every stimulation well to every observation well. If a straight line from a stage along the azimuth of maximum horizontal stress intersects the monitor well, then that line is used to calculate the distance between the two wells. Otherwise, the line to nearest end point of the observation well is used; and 3) For every FDI on every observation well, calculate the overall likelihood that it came from every stage of every stimulation well. The overall likelihood is the product of one or more likelihood functions of fracture slowness, distance traveled or azimuth; 4) Assign the FDI origin to the most likely stage to have caused the FD. If more than one stage is simultaneously stimulated, then it may be useful to also report the second and possibly third most likely stages that caused the FDI.

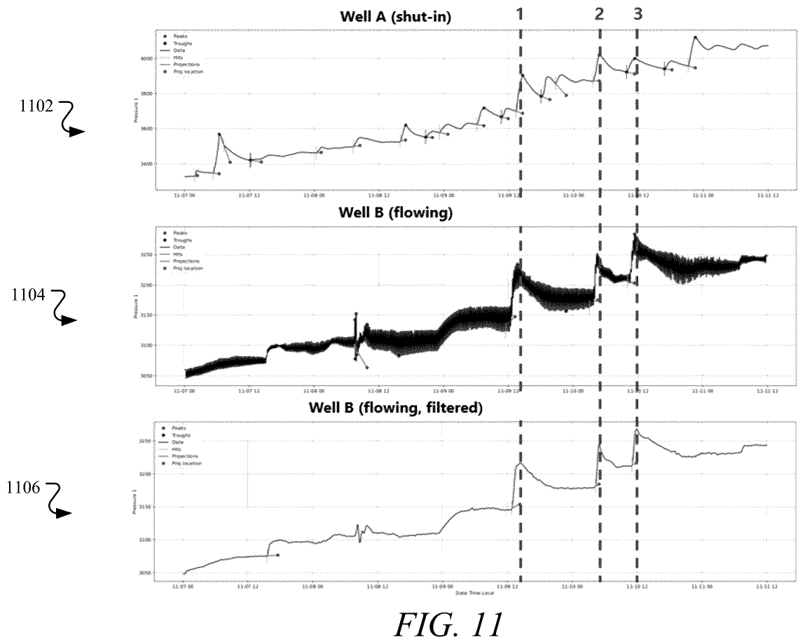

It may at times be desired to detect and analyze FDI from observation wells that are not shut-in. FIG. 11 illustrates the pressure in two wells near an ongoing stimulation job. Well A 1102 was the closest to the stimulation pad at a distance of 2 miles. Numerous FDIs were detected from this well, in this example. Well B 1104, 1106 is illustrated as producing a parent well 4 miles away from the stimulation pad. Its pressure rapidly oscillated, making reliable frac hit detection difficult. However, after the pressure is digitally filtered to remove the high frequency oscillations, Well B illustrates a pressure response as illustrated in graph 1106. From this analysis, four FDIs could then be reliably picked. Further, three of the four FDIs picked on Well B have counterparts in Well A, which occurred at roughly the same time, indicating that these FDIs arise from the same fractures intersecting both wells. The speed at which the fractures travel may help to distinguish whether they are re-openings of a pre-existing fracture (likely in this case) or a new fracture that was just created.

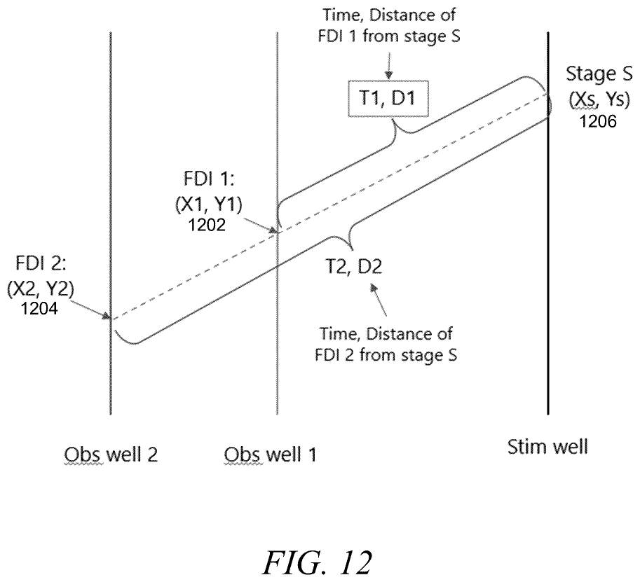

If FDIs are picked from multiple observation wells under the influence of multiple stimulation wells, it may be possible to associate groups of FDIs with the same fracture. FIG. 12 illustrates an automated procedure to determine associating groups of FDIs with the same fracture. In the illustrated scenario, FDI 1 1202 and FDI 2 1204 are both associated with the same Stage S 1206 of the same stimulation well. Stage S 1206 has spatial coordinated (Xs, Ys), while the projected fractures intersected observation wells at spatial locations (X1, Y1) and (X2, Y2), respectively. Furthermore, FDI 1 1202 and FDI 2 1204 occurred after time delays of T1 and T2 relative to the start of Stage S 1206 of the simulation well. In this circumstance, cross-validation of FDI 1 1202 and FDI 2 1204 may come from the same fracture. Although the term “validation” is used herein, the term “high-grading” may also be used. Under a set of simplifying assumptions, the velocity by which a new fracture advances remains roughly constant. These assumptions are:
1. The fracture is bounded above and below within a geologic layer of uniform thickness.
2. The pressure within the fracture remains uniform.
3. The horizontal stresses remain uniform.
4. There is no branching or leakage of fluid from the fracture into the formation.
5. Fluid is being injected into the fracture at a constant rate.
   Assumptions 2 and 3 imply that the fracture opens to a constant width, but no more. When combined with the first assumption, the volume of the fracture is proportional to its length. If there is no branching or leakage, and the rate of fluid pumped is uniform, then the length of the fracture is also be proportional to time pumped.

If indeed the fracture travels at a uniform velocity then the ratio of the time delays equal the ratio of the distance traveled:

$$\frac{{T}_{1}}{{T}_{2}} = \frac{{D}_{1}}{{D}_{2}} .$$

Multiplying both sides of this equation by T2, and noting that exact equality can never be achieved in practice, we can obtain a condition whereby we can somewhat confidently say that the two FDIs are cross-validated, i.e. they are likely to be caused by the same fracture:

$$\vert {T}_{1} - {T}_{2} \frac{{D}_{1}}{{D}_{2}} \vert < 1 / 2 κ ( {T}_{1} + {T}_{2} ) ,$$

where k is a small positive number. The smaller k is set to be, to more stringently the requirement of velocity uniformity is enforced. Cross-validation not only provides evidence that FDIs are associated with the same fracture, but it also increases the likelihood that they are related to any fracture at all, and not a random pressure fluctuation due to a change in flow rate.

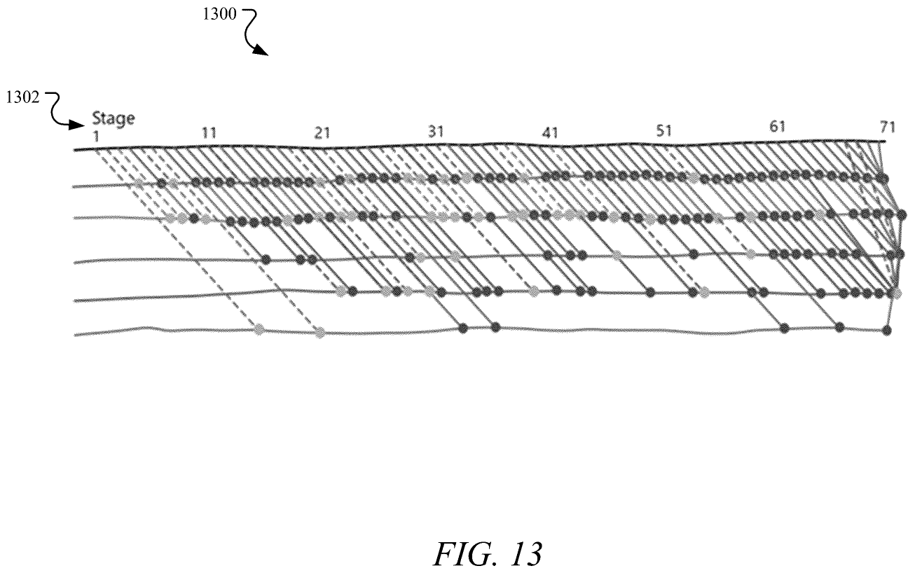

FIG. 13 shows a map 1300 of the fractures that may have been deemed to have emanated from a well as a result of its stimulation. The numbers of each stage 1302 are also shown alongside the top well, i.e., the one that was stimulated. The other five wells are observation wells whose pressures may be monitored during the stimulation. As illustrated, solid fracture lines are those which were cross-validated by the above procedure, and the color of each fracture segment of the map 1300 corresponds to the color of the well with which the segment intersects. Validated FDIs are shown as green dots, while unvalidated FDIs are shown as yellow dots and dashed fracture segments. The unvalidated FDIs and fractures are those which were observed on only one observation well, or whose velocities were insufficiently uniform to qualify them as being uniform with a k of 15%. As should be appreciated, whereas FIG. 10 shows where the FDIs which are observed on a single monitor well came from, FIG. 13 shows where the fractures that originate from a single frac well are observed. Thus it is possible to visualize fracture growth from a single well towards other wells.

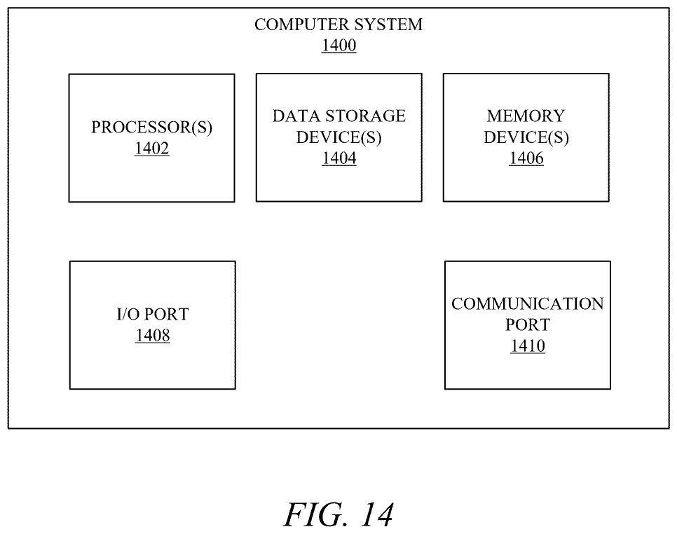

Referring to FIG. 14, a detailed description of an example computing system 1400 having one or more computing units that may implement various systems and methods discussed herein is provided. The computing system 1400 may be applicable to the reservoir depletion assessment platform 102 of FIG. 1, the system 100, and other computing or network devices. It will be appreciated that specific implementations of these devices may be of differing possible specific computing architectures not all of which are specifically discussed herein but will be understood by those of ordinary skill in the art.

The computer system 1400 may be a computing system is capable of executing a computer program product to execute a computer process. Data and program files may be input to the computer system 1400, which reads the files and executes the programs therein. Some of the elements of the computer system 1400 are shown in FIG. 14, including one or more hardware processors 1402, one or more data storage devices 1404, one or more memory devices 1406, and/or one or more ports 1408-1410. Additionally, other elements that will be recognized by those skilled in the art may be included in the computing system 1400 but are not explicitly depicted in FIG. 14 or discussed further herein. Various elements of the computer system 1400 may communicate with one another by way of one or more communication buses, point-to-point communication paths, or other communication means not explicitly depicted in FIG. 14.

The processor 1402 may include, for example, a central processing unit (CPU), a microprocessor, a microcontroller, a digital signal processor (DSP), and/or one or more internal levels of cache. There may be one or more processors 1402, such that the processor 1402 comprises a single central-processing unit, or a plurality of processing units capable of executing instructions and performing operations in parallel with each other, commonly referred to as a parallel processing environment.

The computer system 1400 may be a conventional computer, a distributed computer, or any other type of computer, such as one or more external computers made available via a cloud computing architecture. The presently described technology is optionally implemented in software stored on the data stored device(s) 1404, stored on the memory device(s) 1406, and/or communicated via one or more of the ports 1408-1410, thereby transforming the computer system 1400 in FIG. 14 to a special purpose machine for implementing the operations described herein. Examples of the computer system 1400 include personal computers, terminals, workstations, mobile phones, tablets, laptops, personal computers, multimedia consoles, gaming consoles, set top boxes, and the like.

The one or more data storage devices 1404 may include any non-volatile data storage device capable of storing data generated or employed within the computing system 1400, such as computer executable instructions for performing a computer process, which may include instructions of both application programs and an operating system (OS) that manages the various components of the computing system 1400. The data storage devices 1404 may include, without limitation, magnetic disk drives, optical disk drives, solid state drives (SSDs), flash drives, and the like. The data storage devices 1404 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 1406 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 1404 and/or the memory devices 1406, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 1400 includes one or more ports, such as an input/output (I/O) port 1408 and a communication port 1410, for communicating with other computing, network, or reservoir development devices. It will be appreciated that the ports 1408-1410 may be combined or separate and that more or fewer ports may be included in the computer system 1400.

The I/O port 1408 may be connected to an I/O device, or other device, by which information is input to or output from the computing system 1400. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 1400 via the I/O port 1408. Similarly, the output devices may convert electrical signals received from computing system 1400 via the I/O port 1408 into signals that may be sensed as output by a human, such as sound, light, and/or touch. The input device may be an alphanumeric input device, including alphanumeric and other keys for communicating information and/or command selections to the processor 1402 via the I/O port 1408. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing system 1400 via the I/O port 1408. For example, an electrical signal generated within the computing system 1400 may be converted to another type of signal, and/or vice-versa. In one implementation, the environment transducer devices sense characteristics or aspects of an environment local to or remote from the computing device 1400, such as, light, sound, temperature, pressure, magnetic field, electric field, chemical properties, physical movement, orientation, acceleration, gravity, and/or the like. Further, the environment transducer devices may generate signals to impose some effect on the environment either local to or remote from the example computing device 1400, such as, physical movement of some object (e.g., a mechanical actuator), heating or cooling of a substance, adding a chemical substance, and/or the like.

In one implementation, a communication port 1410 is connected to a network by way of which the computer system 1400 may receive network data useful in executing the methods and systems set out herein as well as transmitting information and network configuration changes determined thereby. Stated differently, the communication port 1410 connects the computer system 1400 to one or more communication interface devices configured to transmit and/or receive information between the computing system 1400 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 1410 to communicate one or more other machines, either directly over a point-to-point communication path, over a wide area network (WAN) (e.g., the Internet), over a local area network (LAN), over a cellular (e.g., third generation (3G) or fourth generation (4G) or fifth generation (5G) network), or over another communication means. Further, the communication port 1410 may communicate with an antenna or other link for electromagnetic signal transmission and/or reception.

In an example implementation, reservoir depletion assessment platform, software, and other modules and services may be embodied by instructions stored on the data storage devices 1404 and/or the memory devices 1406 and executed by the processor 1402. The computer system 1400 may be integrated with or otherwise form part of the reservoir depletion assessment platform 102.

The system set forth in FIG. 14 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for fracture driven interactions diagnostics, the method comprising:
receiving, from a computing device, production data associated with a monitored well that is either shut-in or currently producing;
detecting, by a fracture hit detection model, a fracture hit event at the monitored well, the fracture hit model receiving the production data as an input and outputting an indication of the fracture hit event;
combining the production and pressure data from the monitored well with completion data of one or more nearby wells to determine a plurality of potential origins of the detected fracture hit event; and
tracing a subsurface fracture pathway of the detected fracture hit event by overlaying subsurface data with the plurality of potential origins of the detected fracture hit event.

2. The method of claim 1 further comprising:
generating a fracture hit alert communication comprising the indication of the fracture hit event.

3. The method of claim 2, wherein the fracture hit alert communication further comprises:
a link to access the indication of the fracture hit event and the production data from a fracture diagnostics platform.

4. The method of claim 2, wherein the fracture hit alert communication further comprises:
an instruction executable by a control device of the well, wherein execution of the instruction causes the control device to alter an operation of the well being drilled.

5. The method of claim 1, wherein the fracture hit detection model comprises an autoregressive moving average (ARMA) technique.

6. The method of claim 5, wherein the ARMA technique analyzes at least one past offset well pressure value and at least one projected future offset well pressure value.

7. The method of claim 1, wherein the fracture hit detection model:
recursively adapts itself upon receiving new production and pressure data; and
disincorporates obsolete data from the fracture hit detection model, the obsolete data comprising obsolete predictions of future data values.

8. The method of claim 1, wherein the production data comprises at least one of a water rate measurement, a gas rate, or an oil rate.

9. The method of claim 1, wherein the indication of the fracture hit event comprises a probability of the fracture hit event.

10. A system comprising:
at least one well production measurement device; and
a fracture driven interactions (FDIs) diagnostics platform including an application to detect, by a fracture hit detection model and based on production data received from the at least one well production measurement device, a fracture hit event at a well, the fracture hit model receiving the production data as an input and outputting an indication of the fracture hit event, and trace a subsurface pathway of the detected fracture hit event by combining the production data, completion data of the well, and subsurface data.

11. The system of claim 10, wherein the FDIs diagnostics platform further generates a fracture hit alert communication comprising the indication of the fracture hit event.

12. The system of claim 11, wherein the fracture hit alert communication further comprises a link to access the indication of the fracture hit event and the production data from a fracture diagnostics platform.

13. The system of claim 11, wherein the fracture hit alert communication further comprises an instruction executable by a control device of the well, wherein execution of the instruction causes the control device to alter an operation of the well being drilled.

14. The system of claim 10, wherein the fracture hit detection model comprises an autoregressive moving average (ARMA) technique.

15. The system of claim 14, wherein the ARMA technique analyzes at least one past offset well pressure value and at least one projected future offset well pressure value.

16. The system of claim 10, wherein the fracture hit detection model:
recursively adapts itself upon receiving new production and pressure data; and
disincorporates obsolete data from the fracture hit detection model, the obsolete data comprising obsolete predictions of future data values.

17. The system of claim 10, wherein the production data comprises at least one of a water rate measurement, a gas rate, or an oil rate.

18. The system of claim 10, wherein the indication of the fracture hit event comprises a probability of the fracture hit event.

19. One or more tangible non-transitory computer-readable storage media storing computer-executable instructions for performing a computer process on a computing system, the computer process comprising:
receiving, from a computing device, production data associated with a monitored well that is either shut-in or currently producing;
detecting, by a fracture hit detection model, a fracture hit event at the monitored well, the fracture hit model receiving the production data as an input and outputting an indication of the fracture hit event;
combining the production and pressure data from the monitored well with completion data of one or more nearby wells to determine a plurality of potential origins of the detected fracture hit event; and
tracing a subsurface fracture pathway of the detected fracture hit event by overlaying subsurface data with the plurality of potential origins of the detected fracture hit event.

20. The one or more tangible non-transitory computer-readable storage media of claim 19, wherein the computer process further comprises:
generating a fracture hit alert communication comprising the indication of the fracture hit event.
